(19) United States
(12) Patent Application Publication
(10) Pub. No.: US 2023/0082366 A1
(43) Pub. Date: Mar. 16, 2023

(54) Windshield Fluid Refill Device

(71) Applicant: Alex Miller, Nekoosa, WI (US)

(72) Inventor: Alex Miller, Nekoosa, WI (US)

(21) Appl. No.: 17/944,020

(22) Filed: Sep. 13, 2022

Related U.S. Application Data
(60) Provisional application No. 63/244,144, filed on Sep. 14, 2021.

(51) Int. Cl. B67D 7/02; B60S 5/00; B67D 7/04; B67D 7/22; B67D 7/78

(52) U.S. Cl. CPC B67D 7/0294; B60S 5/00; B67D 7/04; B67D 7/222; B67D 7/78

(57) ABSTRACT

The Windshield Mojo is the only product of its kind that enables users to choose the amount of fluid to be dispensed into the vehicle's windshield reservoir and therefore guarantees a smoother, quicker, and more cost-effective operation. The Windshield Mojo is uniquely designed with a digital screen to enhance functionality and a coin and a card insert for easy payment and quick utilization.

### BACKGROUND

For most car owners, experiencing problems with their windshields is a highly probable situation that usually is a result of an empty washer fluid reservoir. To solve this problem, individuals must purchase washer fluid that can be found a local gas stations or automotive stores, however, the fluid is most commonly sold in gallons or bulk and for most conventional vehicles washer capacity is limited and does not require such large quantities of fluid. This in return creates a costly and inconvenient situation for car owners and requires individuals to find space to store large, partially full, jugs. There have been no products available as original equipment or as an aftermarket to address this problem.

An apparatus to simplify the process of refilling oil in your vehicle. There have been no products available as original equipment or as an aftermarket to address this problem either.

There exists a need for a device and a system such as the Windshield Fluid Refill Device that is not being met by any known or disclosed device or system of present.

### SUMMARY OF THE INVENTION

The main purpose of the Windshield Fluid Refill Device is to provide users with a machine that dispenses windshield washer fluid, in order to fill a vehicle, based on a paid time dispenser.

### BRIEF DESCRIPTION OF THE DRAWINGS

FIG. 1 is a front perspective view of the Windshield Fluid Refill Device in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

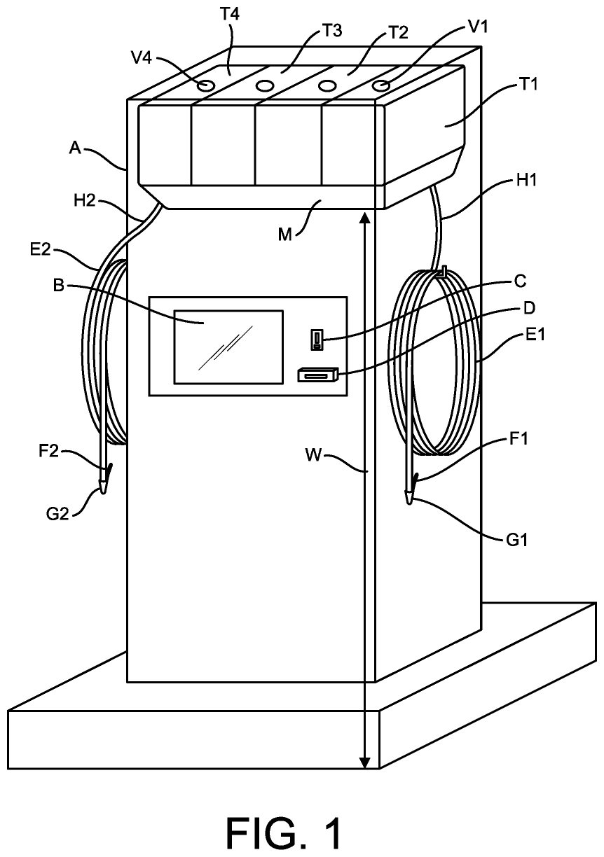

FIG. 1 is a front perspective view of the Windshield Fluid Refill Device showing: Windshield fluid dispenser machine referenced as A., Digital screen referenced as B., Coin insert referenced as C., Card insert referenced as D., Spool of hose referenced as E1, Trigger to start dispensing referenced as F1, Nozzle with fluid level sensor referenced as G1, in accordance with an embodiment of the present disclosure. The depiction also includes another tank T2, T3 and T4, another hose H2, another hose spool E2, another trigger F2 and another nozzle G2. The depiction further includes an air input valve V1 and V4 for respective tanks T1 and T4 engineered to equalize an air pressure in the respective tank to compensate for a fluid loss through the respective hose and respective nozzle. The height W from a base of the respective tank to the surface the dispenser machine, also known as a vending machine upon which it sits, determines a weight of the respective vehicle maintenance fluid by a mass thereof times a gravity acting thereon. A difference between a height W of the respective tank of the disclosure and a height of the vehicle tank receiving the vehicle maintenance fluid determine the respective fluid pressure in the hose and nozzle and a delivery time thereof. The valve M or 2 of 4 multiplexor selector of a two vehicle maintenance fluids into two respective hoses allows 4 total or two other vehicle maintenance fluids to be tanked or stored in the disclosure and vended to a customer.

The present disclosed Windshield Fluid Refill Device, also known as “Windshield Mojo”, provides a reliable and robust windshield washer fluid dispensing system that fills a vehicle's reservoir with the adequate amount of fluid to provide a cost effective and environmentally friendly solution to this worldwide inconvenience. Expanding on the initial design of a gasoline dispenser, the Windshield mojo introduces a novel machine with a trigger, hose, and nozzle able to dispense the fluid into the automobile empty windshield fluid bank. The user simply inserts the prescribed method of payment, quarters, whereas once the user pays 50 to 75 cents, the unit runs on a time metric and begins to flow washer fluid from the holding tank into the hose. The hose employs a spring loaded spool up to 10 feet to reach the vehicle tank and possesses a handle at the end to control the flow until the process is complete in which the hose winds back up. The Windshield Mojo ensures a fully operational windshield fluid dispenser machine at all times and therefore eliminates the need for users to purchase gallons of fluid that would otherwise go to waste. This innovative, top quality device can be placed in gas stations, mechanic shops and auto stores to provide a convenient one stop windshield fill location.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A vehicle maintenance system for a vehicle comprising:
a tank comprising a vehicle maintenance fluid suspended a height above a driving surface for the vehicle;
a hose comprising a dispensing end and a tank end in communication with the tank; and
a trigger nozzle on the dispensing end configured to allow a weight of the vehicle maintenance fluid to push it there through.

2. The vehicle maintenance system of claim 1, wherein the vehicle maintenance fluid is a windshield washing fluid.

3. The vehicle maintenance system of claim 1, further comprising a digital screen and digital processor configured to monitor a vending of the vehicle maintenance fluid.

4. The vehicle maintenance system of claim 1, further comprising a credit card reader in relation to a vending of the vehicle maintenance fluid.

5. The vehicle maintenance system of claim 1, further comprising a coin reader in relation to a vending of the vehicle maintenance fluid.

6. The vehicle maintenance system of claim 1, further comprising an adjacent spool for a coil of the hose.

7. The vehicle maintenance system of claim 1, wherein the vehicle maintenance fluid comprises a windshield wiper fluid, a radiator coolant, a power steering fluid, an engine oil and a brake fluid.

8. The vehicle maintenance system of claim 1, further comprising another tank, another hose and another trigger nozzle configured in an intra communication there with.

9. The vehicle maintenance system of claim 1, further comprising a valve configured to pass one of a multiple vehicle maintenance fluids suspended in a plurality of tanks.

10. The vehicle maintenance system of claim 1, further comprising the trigger nozzle configured to prevent the vehicle maintenance fluid there through based on a sensing of the vehicle maintenance fluid thereon.

11. The vehicle maintenance system of claim 1, wherein a trigger of the trigger nozzle is a mechanical pressure of the trigger against a vehicle tank configured to receive the vehicle maintenance fluid.

12. The vehicle maintenance system of claim 1, wherein a trigger of the trigger nozzle is an electronic signal from an electronic controller.

13. The vehicle maintenance system of claim 1, wherein the trigger of the trigger nozzle is a mechanical communication from a vending of the vehicle maintenance system.

14. The vehicle maintenance system of claim 1, wherein the trigger nozzle is an electronic signal from a vending of the vehicle maintenance fluid.

15. The vehicle maintenance system of claim 1, further comprising a vending machine configured to house the tank, the hose, the trigger and a vending system of the vehicle maintenance fluid.

16. The vehicle maintenance system of claim 1, further comprising a four to two multiplexor selector valve configured to allow any two selected fluids to pass into two each respective hoses in communication with a tank of four separate maintenance fluids.
